(19) United States
(12) Patent Application Publication
(10) Pub. No.: US 2009/0174935 A1
(43) Pub. Date: Jul. 9, 2009

(54) SCANNING MICROSCOPE HAVING COMPLEMENTARY, SERIAL SCANNERS

(76) Inventors: Michael J. Szulczewski, Middleton, WI (US); William I. Vogt, Baraboo, WI (US)

Correspondence Address: Intellectual Property Department;DEWITT ROSS & STEVENS S.C., Suite 600, 2 East Mifflin Street, Madison, WI, 53703-2865, US

(21) Appl. No.: 11/971,552

(22) Filed: Jan. 9, 2008

(51) Int. Cl. G02B 21/00

(52) U.S. Cl. 359/368

(57) ABSTRACT

Described is a scanning microscope that includes at least two scanners disposed in series within an excitation beam, wherein one of the scanners is a two-axis galvanometer-controlled scanner, and the other of the scanners is a single-axis resonant scanner. The device may also include a spatial detection system disposed within the excitation beam at a point downstream of the at least two scanners, wherein the spatial detection system is configured to detect a sum of deflections generated by the at least two scanners, or to detect angular differences in the excitation beam when two or more illumination sources are used.

### FIELD OF THE INVENTION

The invention is directed to a scanning microscope having complementary scanner disposed in serial fashion that enable high-speed scanning of wide fields of view at low-power and high resolution.

### BACKGROUND

A number of factors determine the performance characteristics and flexibility of a scanning microscope when used with large aperture objectives. These factors include (by way of illustration and not limitation): input illumination beam diameter, scanner mirror size, scanner deflection angle, scanning speed, scan lens/tube lens optical magnification ratio, objective lens magnification and numerical aperture (NA) (ultimately, pupil size of the objective lens), and field of view. These interacting factors often require unwanted equipment compromises when designing scanning microscopes for use in applications that require wide-field (i.e., low magnification) images, taken at maximum resolution. Further compromises are also made to accommodate high-speed acquisition of full-field images, and/or a sub-region images and linescans.

Moreover, the interrelationship between these factors is inherently performance-limiting and increasingly comes into play when the microscopy includes a large diameter objective lens. The interrelationship between these factors is best illustrated by a description of conventional scanning confocal microscopes. FIGS. 1, 2, and 3 are schematic drawings that illustrate prior art, conventional designs of various types of confocal microscopes and multiphoton microscopes. The same reference numerals are used in all of FIGS. 1, 2, and 3 to designate the same elements in each of the drawings.

FIG. 1 schematically illustrates the excitation path of a conventional scanning microscope. Illumination source 1 can be a laser or any other illumination source known to the art. The illumination source 1 can provide light in any wavelength, but is typically between about 325 nm and 1500 nm. The illumination source can provide a pulsed input beam or a continuous input beam. Collimated excitation light 10 from the illumination source 1 is directionally scanned by a dual axis scanner 2 comprised of two orthogonally scannable mirrors (i.e., vertical and horizontal, unnumbered). The scanned light is transferred by an optical relay comprising a scan lens 3, a tube lens 6, and an objective lens 8. This arrangement of optical elements yields a focused beam of light 9 at the sample plane to trace a selected pattern determined by the dual axis scanner 2. (The mirror 5 is not fundamental to the system but is included for illustration formatting.)

FIG. 2 schematically illustrates the illumination path shown in FIG. 1, along with a de-scanned confocal detector 17 for confocal detection. Once the excitation light is brought to focus 9 at the sample (as in FIG. 1) the light is allowed to interact with the sample. Depending on the sample and input illumination, this interaction results in many forms of intensity modulation of the excitation light, as well as fluorescent emission if a fluorophore is at or near the focal point. A portion of this modulated or fluorescent emission light will be collected by the objective lens 8 and travel back through the scanning system where it is made stationary (i.e., descanned) and brought to a focus at a confocal aperture 15. In the case of single-photon absorption microscopy or reflection microscopy this modulation or emission is not necessarily local to the focused excitation light at the sample. In this instance, the confocal aperture 15 will reject most non-local modulated or emitted light, and thereby improve the resolution of the acquired image. When multiphoton absorption is producing the desired modulation or emission, the confocal aperture 15 is not needed.

FIG. 2 illustrates the conventional method of adding a descanned confocal detector 17 to the scanning system. By inserting a light-dividing device 12 (such as a dichroic, polychroic, polarizing beam splitter, or neutral beam splitter) into the light path between the illumination source 1 and the dual axis scanner 2, the emitted or reflected light from the sample can be separated from the excitation light path, filtered by an optical filter 13, focused with a lens 14, spatially filtered by an aperture located at the focus plane 15, and detected by a photosensitive device 16. The optical filter 13 and spatial filter 15 are optional.

FIG. 3 schematically illustrates the illumination path shown in FIG. 1, along with a non-descanned detector 21. This type of instrument is used in multiphoton microscopy (where simultaneous or near-simultaneous absorption of two or more photons of lower energy are used to stimulate emission of a higher energy photon from a fluorophore present at the focal point 9). Here the excitation is provided by a pulsed illumination source 1. Multiphoton absorption within the sample gives rise to a localized fluorescent emission. Because the fluorescent emission is local to the focused excitation point 9 it is desirable to omit the confocal aperture. Omission of the confocal aperture also obviates the need to descan the light that is to be detected. Thus, an effective optical detection arrangement is illustrated in FIG. 3. Here, a non-descanned detector 21 comprising a focusing lens 19, and a photodetector 20 is used. A conventional light-separating device 18 (as noted earlier) is used to direct emitted light to the detector 21. As shown in FIG. 3, the light to be detected is separated from the excitation illumination at a plane very near the objective lens. The emitted light is sent through a simple optical system (e.g., lens 19), without descanning, to a photodetector 20. A distinct advantage of this arrangement of optical elements is that a wider angle of emitted light collection is possible because the cross-sectional area of the emission path is not restricted by the component size of the excitation path. An additional advantage of the system illustrated in FIG. 3 is the reduced number of air-glass surfaces between the objective lens 8 and the photodetector 20. These air-glass surfaces contribute to unwanted reflections and signal reduction.

While these conventional microscopes are suitable for many uses, when wide-field, high-resolution images are desired the equipment design compromises become untenable. Most notably, scanning a wide field of view at high resolution takes time. When maximum resolution is desired, and the field to be imaged is large, the acquisition time required by the microscope becomes unacceptably long.

Other types of scanners, most notably resonant scanners, have been used in commercial scanning microscopes to increase image acquisition speed. Galvanometer-controlled mirrors function on the same principles as an electric motor, with the mirror being attached to one end of the motor axle. Current passing through the galvanometer deflects the mirror along a calibrated arc. In contrast, a resonant mirror scanner has the mirror mounted on a spring plate which is then electronically oscillated at its resonant frequency. Thus, unlike a galvanometer-controlled mirror whose scan frequency can be adjusted, a resonant scanner generally operates at only a single frequency (i.e., the resonant frequency). Frequency adjustable resonant scanners have, however, been described. (See, for example, WO/2002/037164, published May 10, 2002.) To take advantage of the inherent differences between galvanometer-controlled scanners (greater positional control) and resonant scanners (faster image acquisition) there is one commercially available microscope that can alternatively use one or the other type of scanner, the Leica TCS SP5 (Leica Microsystems, Mannheim, Germany). The TCS SP5 device, however, is not capable of using both types of scanners simultaneously or in cooperation with one another. This device operates on an either/or basis, using either a galvanometer-controlled scanner or a resonant scanner. The two scanner types are disposed on a carriage that moves each scanner alternatively into the beam path.

### SUMMARY

The invention is directed to a scanning microscope comprising at least two complementary scanners disposed in series within the excitation beam of the microscope. The two scanners are complementary in the sense that they operate on different physical principles. One of the scanners comprises a two-axis galvanometer-controlled scanner. The other of the scanners comprises a high-speed, single-axis resonant scanner, preferably a single-axis resonant scanner.

The excitation beam in the microscope is generated by one or more illumination sources, such as lasers. Thus, when the microscope comprise more than one (i.e., at least two) illumination sources, it also includes a beam combiner configured to combine illumination generated by the at least two illumination sources into a combined excitation beam.

For detecting photons emitted or reflected from the sample being imaged, the microscope further comprises a descanned confocal photodetector, a non-descanned photodetector, or both a descanned confocal photodetector and a non-descanned photodetector.

In all versions of the invention, the microscope further may comprise a spatial detection system disposed within the excitation beam at a point downstream of the scanners. The spatial detection system is configured to detect the sum of deflections generated by the complementary, serial scanners, or to detect angular differences in the combined excitation beam when two or more illumination sources are used. The positioning of the spatial detection system may vary. In versions comprising a scan lens, a tube lens, and an objective lens, the spatial detection system may be disposed within the excitation beam at a point after the excitation beam has exited the scanners but prior to the excitation beam entering the scan lens. Alternatively (or simultaneously), the spatial detection system may be disposed within the excitation beam at a point after the excitation beam has exited the tube lens but prior to the excitation beam entering the objective lens.

Another version of the scanning microscope according to the present invention comprises at least three scanners disposed in series within the excitation beam. In this version of the invention, one of the scanners is a two-axis galvanometer-controlled scanner, and the other two of the scanners are high-speed, single-axis scanners, preferably single-axis resonant scanners. These two single-axis scanners are preferably disposed orthogonally to one another. As in previous versions of the invention, this embodiment of the microscope may comprise a descanned confocal photodetector, a non-descanned photodetector, or both a descanned confocal photodetector and a non-descanned photodetector.

### BRIEF DESCRIPTION OF THE DRAWINGS

FIG. 1 is a schematic rendering of the illumination path of a conventional, prior art scanning microscope.

FIG. 2 is a schematic rendering of the illumination path of a conventional, prior art scanning microscope as shown in FIG. 1, with the addition of a descanned confocal detector 17.

FIG. 3 is a schematic rendering of the illumination path of a conventional, prior art scanning microscope as shown in FIG. 1, with the addition of a non-descanned detector 21 for use in multiphoton imaging protocols.

FIG. 4 is a schematic rendering of the excitation path of a first version of a microscope according to the present invention having complementary scanners 22 (single axis scanner) and 2 (two axis scanner).

FIG. 5 is a schematic rendering of the excitation path of a second version of a microscope according to the present invention having complementary scanners 28, 22 and 2.

FIG. 6 is a schematic rendering of the excitation path as shown in FIG. 4, having added thereto descanned confocal detector 17, and non-descanned detector 21.

FIG. 7 is a schematic rendering of the excitation path as shown in FIG. 5, having added thereto descanned confocal detector 17, and non-descanned detector 21.

FIG. 8 is a schematic rendering of the excitation and detection path of a third version of the invention having two illumination sources (1 and 41) and a position-sensitive detector 35.

FIG. 9 is a schematic rendering of the excitation and detection path of a fourth version of the invention. Here, the microscope comprises a single illumination source 1, complementary scanners 22 and 2, spatial detector 35, and both a descanned confocal detector (comprised of elements 12-16) and a non-descanned detector (comprised of lens 19 and photodetector 20). The spatial detector 35 is inserted in the light beam between scanner 2 and scan lens 3.

FIG. 10 is a schematic rendering of the excitation and detection path of a fifth version of the invention. Here, the microscope comprises two illumination sources 1 and 41, complementary scanners 22 and 2, spatial detector 35, and both a descanned confocal detector (comprised of elements 12-16) and a non-descanned detector (comprised of lens 19 and photodetector 20). Here, in contrast to FIG. 9, the spatial detector 35 is inserted in the light beam between objective lens 8 and tube lens 6.

### DETAILED DESCRIPTION OF THE INVENTION

The various lenses, mirrors, galvanometer-driven mirrors, beam splitters and beam combiners, resonant scanners, and sub-assemblies described herein all depicted in the figures as single lenses or mirrors. This may or may not be the case and is only used in the drawing figures for brevity and clarity. Each “lens” and “mirror” may comprise any number of lenses and/or mirrors to accomplish the stated task. Thus, where appropriate, these structures are referenced in terms of the functional result to be obtained. For example, the term “beam-combiner” refers to any structure, such as a dichroic mirror or suitable lens or lenses, or any combination of lenses or mirrors, which accomplishes the functional goal of combining two independent light beams. Lenses, mirrors, galvanometers, resonant scanners, beam-combiners and the like, suitable for use in the present invention, may be obtained from any number of commercial suppliers. For example, suitable optical components can be obtained from GSI Lumonics (Billerica, Massachusetts), JML Direct Optics (Rochester, N.Y.), Chroma Technologies (Brattleboro, Vt.), Electro-Optical Products Corp. (Glendale, N.Y.), Nikon Instruments Inc. (Melville, N.Y.), and Olympus America Inc. (Center Valley, Pa.).

Likewise, the photodetector used in the invention may be any type of image detector now known or developed in the future for processing light (i.e., electromagnetic radiation, including, without limitation, visible, UV, and IR) into images or digital data streams that can be further manipulated via computer. Included within this definition are digital cameras, film cameras, charge-coupled devices of any and all description, photomultiplier tubes, and single and multi-channel photon detectors of any and all description. Collectively, these devices are referred to herein as photodetection means or simply a photodetector. In short, the photodetector used in the invention is not critical, so long as the chosen device functions to detect the particular wavelength of radiation used in the invention. Photodetectors suitable for use in the present invention can be obtained from numerous commercial suppliers, including Hamamatsu Corporation (Bridgewater, N.J.) and Roper Scientific (Trenton, N.J.).

The illumination source used in the subject invention can be any type of light source that generates the desired wavelength of electromagnetic radiation. A laser light source is preferred. Suitable light sources are available commercially from many of the suppliers listed earlier, as well as Melles Griot (Carlsbad, Calif.) and Coherent Laser Group (Santa Clara, Calif.).

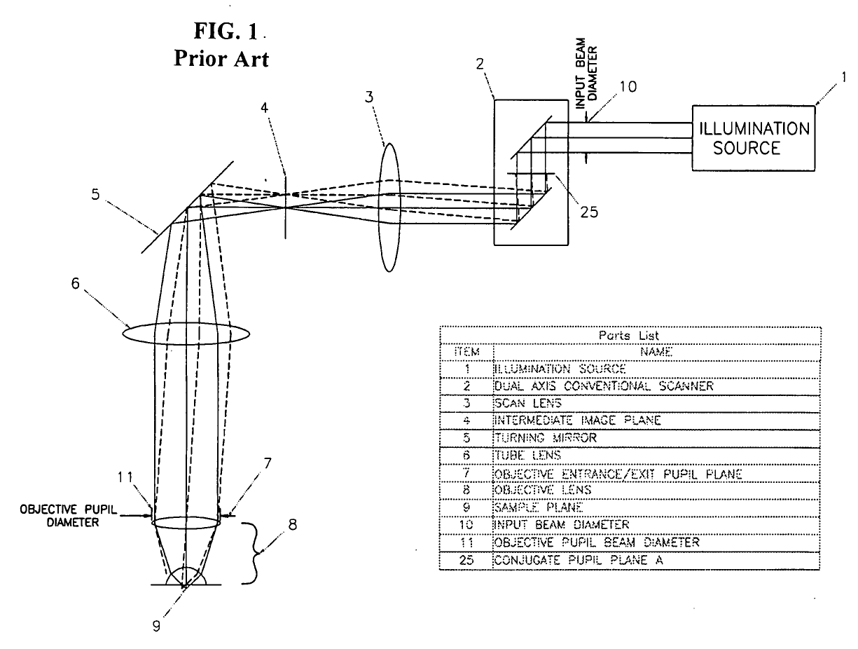

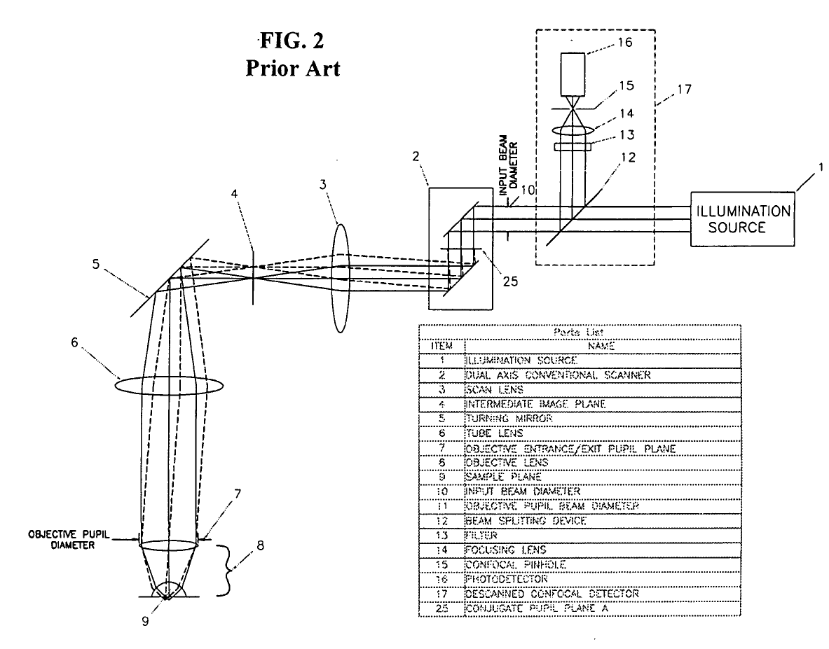

For purposes of clarity, the electronic controllers, galvanometers and oscillators that drive the scanners 2, 22, and 28 have been omitted from all of the figures. These controllers and electromechanical components are conventional at can be obtained from the commercial suppliers listed previously (e.g., Nikon, Olympus, Electro-Optical Products, etc.) Referring to FIGS. 1, 2, and 3 (the prior art devices), a conjugate pupil plane 25 is arranged by design to be at the center of the dual axis scanner device 2. The conjugate pupil plan 25 is optically imaged at the objective entrance pupil 7 by scan lens 3 and tube lens 6. The objective lens 8, having its entrance pupil filled by this collimated scanning beam of excitation light, focuses this light at the sample plane.

Note, however, that there is a magnification of the pupil image projected to the objective entrance pupil 7. The magnification is determined by the focal length ratio of the scan lens 3 to the tube lens 8. Along with the magnification of the pupil image, there is an inverse magnification relation with the scanned angles at the dual axis scanner 2; those angles are also projected to the objective lens 8 by the lens pair 3 and 6. For any given angle at the dual axis scanner 2, the corresponding scanned angle received by the objective lens 8 decreases approximately by the inverse of the magnification ratio. By optical principles, the field of view at the sample 9 is likewise reduced by this inverse ratio. As a result, to maintain the same field of view with a higher magnification optical relay, the dual axis scanner 2 must deflect to greater angles.

These relationships yield an inherent difficulty in constructing a scanning microscope that is optimal for use with very large objective pupils. It is vitally important that the objective lens pupil be matched by the beam diameter so that the objective can operate at full numerical aperture, thereby producing the smallest focused beam size at the sample and the highest resolution. (If the beam diameter is significantly smaller than the objective lens pupil, the full potential of the objective lens will not be realized.) To magnify a given input beam to fill the pupil of a large objective lens, the magnification ratio of the lens pair 3 and 6 must be increased. This can be accomplished by using stronger (i.e., more complex, shorter focal length) scan lenses 3, and/or weaker (longer focal length) tube lenses 6, while also increasing the scanned angle at the dual axis scanner 2 proportionately.

Popular low power/high NA water immersion objective lenses are currently in the 18-20× range, with numerical apertures between about 0.95 and 1.1, and pupil diameters of about 17 millimeters. The specifications of these objective lenses represent a practical design limit being reached by the excitation and detection path designs of current scanning microscopes. In short, integrating a low power, high NA, large diameter objective lens into a conventional scanning microscope necessarily requires compromises in scanner size, scanner speed, field of view, and scan lens aberrations. These necessary compromises yield a microscope that does not take advantage of the full potential of the large diameter objective lens.

The present invention is an apparatus for accommodating objective lenses having considerably larger pupils than are currently available, while simultaneously increasing the image acquisition speed and flexibility of the microscope to take images in many different modes (confocal, multiphoton, reflection, emission, stimulated emission, etc.).

One approach to reducing the required magnification ratio of the scan lens and tube lens to fill a large aperture objective is simply to increase the input illumination beam size. However, increasing the beam size also requires that the clear aperture of the scanning elements (mirror galvanometers, etc.) be increased proportionally. In the case of a mirror galvanometer, the mirror size would be increased. But the mirror size increase yields an unavoidable increase in the mass of the mirror, and a corresponding decrease in the speed and agility of the mirror/galvanometer combination. The overall result is slower scanning and imaging. A benefit, though, of using larger mirrors and galvanometer motors is that there are commercial designs available that provide improved angular resolution and repeatability relative to their smaller, faster counterparts.

The present invention takes advantage of the improved angular resolution and repeatability of large galvanometers, while limiting the disadvantage of the slow speed of these large galvanometers by placing an additional scanning sub-assembly, of complementary characteristics, in serial fashion to the existing scanner design. In short, the microscopes according to the present invention have at least two serially placed scanning devices, wherein at least one of the scanners operates on different physical principles than the other(s). The two scanners operate simultaneously and are both situated within the beam path simultaneously. These “hybrid” microscopes take advantage of the large diameter objectives and corresponding large mirror galvanometers, without sacrificing image acquisition speed.

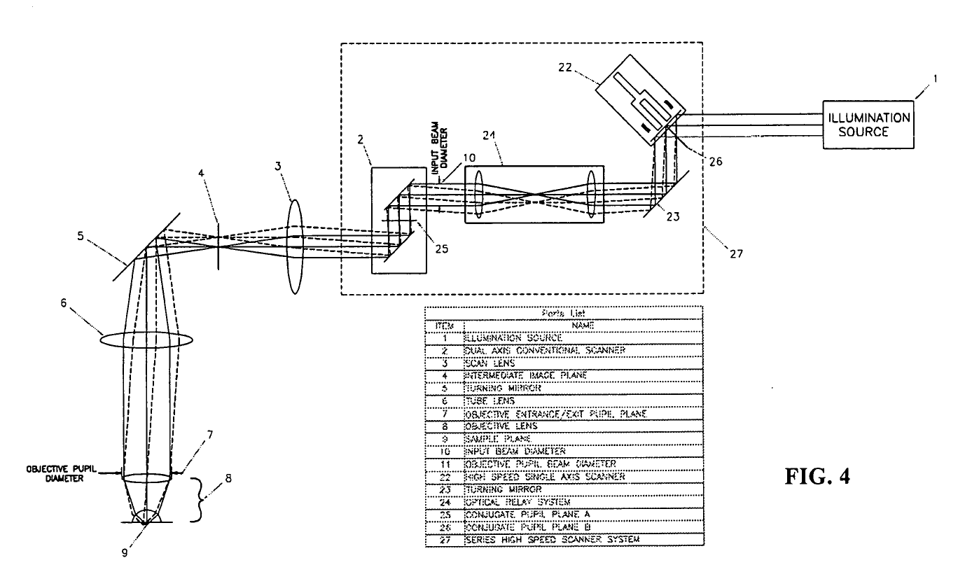

The excitation path of a first version of the invention is depicted schematically in FIG. 4. The apparatus shown in FIG. 4 includes a dual-axis scanner 2 comprised of a pair of galvanometer-controlled mirrors, and a single-axis scanner 22 which is a resonant scanner. FIG. 4 illustrates the fundamental basis of this present invention. FIG. 4 shows an additional scanning device 22, of complementary characteristics to mirror galvanometer 2, integrated into the excitation path in a serial manner forming a hybrid system.

As shown in FIG. 4, the complementary scanner 22 is single-axis resonant scanning mirror, as contrasted to the dual-axis galvanometer-controlled mirrors contained in scanner 2. The combination of the two scanners 2 and 22 and the intervening optical relay system 24 is designated in FIG. 4 as the series high-speed scanner 27. The series high-speed scanner system 27 is preferably comprised of a resonant scanning mirror 22, a galvanometer mirror scanner 22, and an optical relay system 24 disposed between the two different types of scanners. (The mirror 23 is not fundamental to the system but is included for illustration formatting.) Resonant scanners have relatively large mirror sizes and are able to scan at line rates of 16 kHz or more. By design, the invention is arranged so that a conjugate pupil plane 26 is positioned at the center of the high-speed scanner 22. The optical relay 24 transfers an image of the conjugate pupil plane forward to the conjugate pupil plane 25 located between the galvanometer-controlled mirrors of the scanner 2.

When arranged in this manner the scan contribution of all three scanning mirrors (i.e., the single mirror of resonant scanner 22 and the two mirrors of galvanometric scanner 2) are combined such that they can be relayed forward to the objective lens in the standard manner. It is then possible, through independent control of the three scanning mirrors, to combine their characteristics advantageously in various ways. Note that the utility of the invention is not limited to the case of a microscope using large aperture objectives, although this is the primary utility of the invention. The large mirror size and high speed contributed by the resonant scanner 22 provides a convenient method for presenting a large input beam to the scan system while simultaneously providing a mechanism for scanning at very high line rates (greater than about 16 kHz). For example, the high-speed axis provided by resonant scanner 2 can be combined with the scanning motion contributed by using only the orthogonal axis of the galvanometric scanner 2 to produce frame rates of more than 30 frames per second over the full field of view.

Alternatively, the high-speed scanner 22 may be held stationary, while the conventional scanners can be used in situations where best resolution, high zoom factors, and extreme accuracy are important. Even if the high-speed scanner 22 is held stationary, it remains within the beam path.

Another very useful action that is achieved with the combined action of the series scanners 22 and 2 is that of rapidly and sequentially visiting a number of sub-regions of the field of view while independently keeping the additional scan mechanisms in operation (i.e., “tiling” or region-of-interest scanning). Some commercially available high-speed scanners 22 may have settling times, restricted field of view, or limited offset capability. By combining the action of these types of scanners 22 with that of the conventional galvanometric scanner 2, the scanner 22 can continue operating under reduced field of view conditions, while the scanner 2 is used to shift this reduced scan pattern about within the within the overall field of view available.

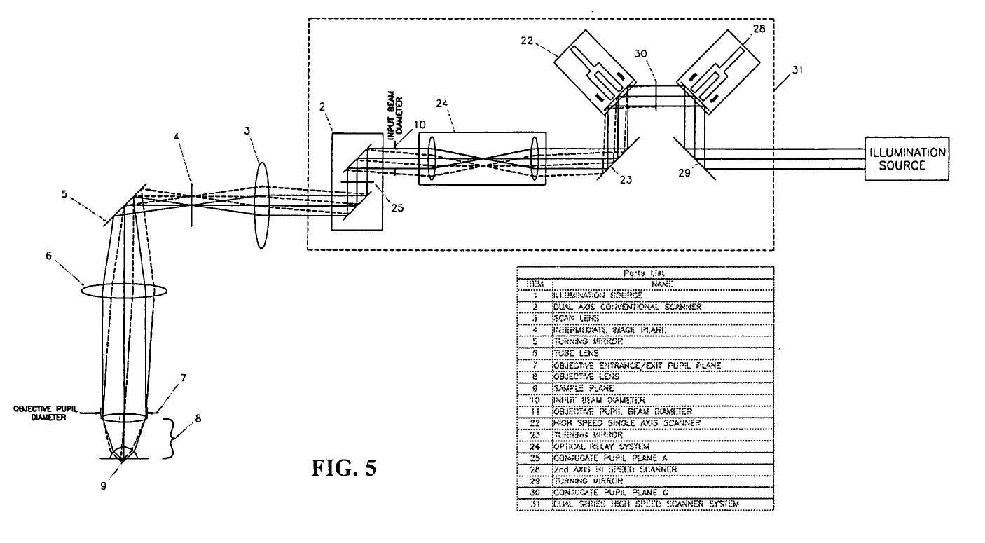

In a similar fashion, FIG. 5 depicts a second version of the invention wherein the two-axis galvanometric scanner 2 is paired in series with a two high-speed scanners (22 and 28) having different scan axes to one another. (The scan axes are preferably orthogonal to one another, but this is not required.) FIG. 5 is a schematic illustration of the excitation path only. In FIG. 5, an additional high-speed scanner (preferably a resonant scanner) 28 is added to the device. In this version of the invention, the optical design varies from that shown in FIG. 4 so as to establish a conjugate plane 30 at a position between the two high-speed scanners 22 and 28. In the version shown in FIG. 5, the contributions of four different scanning mirrors (two in the galvanometric scanner 2, and one each in high-speed scanners 22 and 28) can be combined through independent controllers (not shown). Although not limited to orthogonally disposed mirrors, one benefit of the apparatus shown in FIG. 5 is that the orientation within the field of view of the high-speed scan direction generated by scanners 22 and 28 can be switched orthogonally from horizontal to vertical, or by combining contributions of multiple scanners, can produce a high-speed diagonal scan.

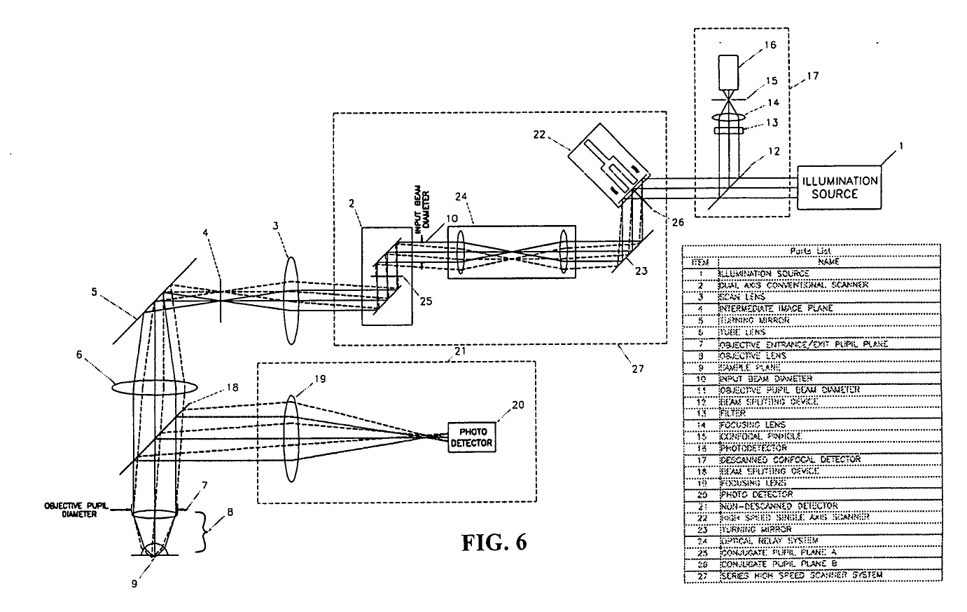

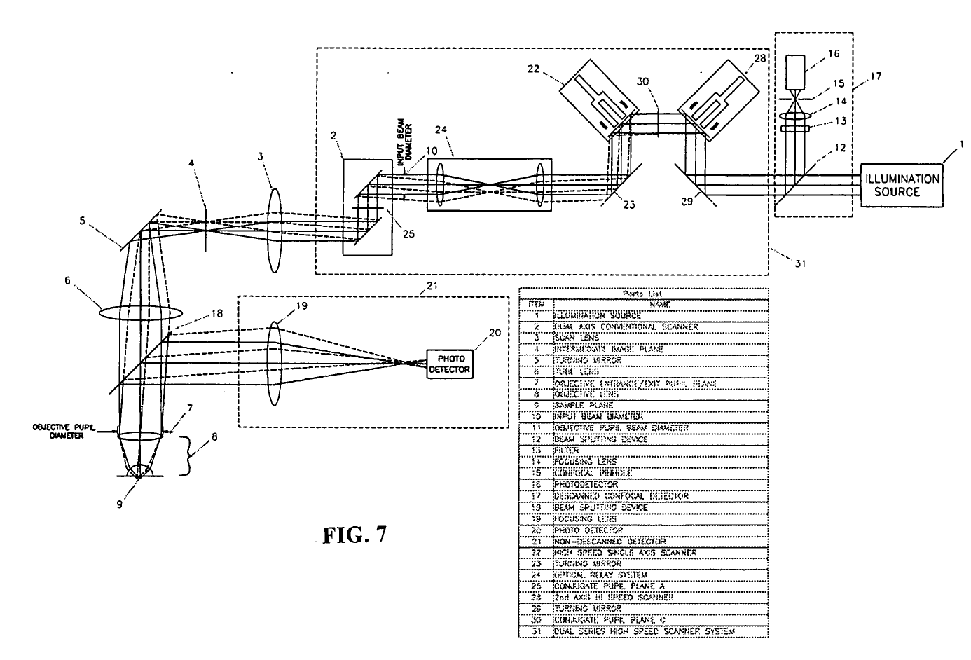

FIGS. 4 and 5 depicted just the excitation path of two versions of the present invention. FIGS. 6 and 7 depict corresponding devices with a descanned confocal detector 17 and/or a non-descanned detector 21 Thus, FIG. 6 corresponds to FIG. 4, and includes, in series, a single-axis high-speed scanner 22 and a conventional two-axis galvanometric scanner 2, as well as a descanned confocal detector 17 and a non-descanned detector 21. Either one of the detectors or both of the detectors may be present. The descanned confocal detector 17 (generally comprised of beam splitter 12, filter 13, lens 14, confocal pinhole 15, and photodetector) is for use in conventional confocal microscopy, reflection microscopy, single-photon fluorescent emission microscopy, and the like, where out-of-focus light needs to be spatially filtered before impinging on the photodetector. The non-descanned detector 21 (generally comprised of focusing lens 19 and photodetector 20) is for use in multiphoton protocols that do not require spatial filtering. In the case of confocal detection, the light from the sample is transferred back through the optical system, is descanned by all contributing scan devices, and is brought to the photodetector through confocal pinhole 15 as described previously. With the hybrid design the non-descanned detector 21 also functions as described previously. A beam splitter 18 is disposed between tube lens 6 and the objective lens 8 to direct emitted light into the non-descanned detector 21

Similarly, FIG. 7 corresponds to FIG. 5, and includes, in series, two single-axis high-speed scanners 22 and 28 (resonant scanners) and a conventional two-axis galvanometric scanner 2, as well as a descanned confocal detector 17 and a non-descanned detector 21. Either one of the detectors or both of the detectors may be present. The detectors 17 and 21 are as described in the preceding paragraph. In the case of confocal detection, the light from the sample is transferred back through the optical system, is descanned by all contributing scan devices, and is brought to the photodetector through confocal pinhole 15 as described previously. The non-descanned detector 21 also functions as described previously. A beam splitter 18 is disposed between tube lens 6 and the objective lens 8 to direct emitted light into the non-descanned detector 21.

The combination of scanners in series as described herein provides a highly flexible range of system performance that balances high-speed image acquisition with high-resolution, wide-field images. The flexibility of the device is further increased by incorporating into the microscope a feedback system that enables precise coordination of the scan angles contributed by the multiple independent scanners. A precision feedback mechanism enables bias and gain corrections for each independent scanner to be calculated so that their scan angles can be arranged precisely as desired relative to each other. The ability to set these angles accurately and precisely ensures that the scan pattern and direction of one scanner precisely matches the equivalent scanner axis of the series arrangement so that when switching between modes using either or both of the scanners produces exactly the same field of view and location.

The feedback mechanism also enables coordinating the position of reduced scan areas (mentioned earlier in regard to tiling or region-of-interest scanning) relative to the overall field of view. This enhances the ability of the microscope to visit and accurately to revisit specific sub-regions of the overall field of view. In turn, this greatly enhances the ability of the microscope to improve quickly stitching together multiple sub-region images into a composite, mosaic image.

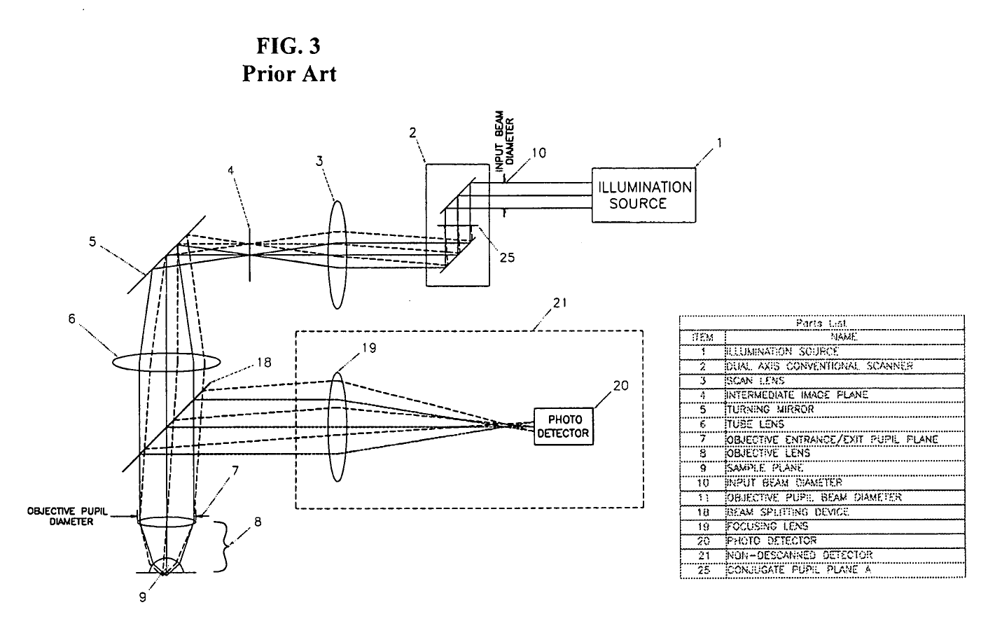

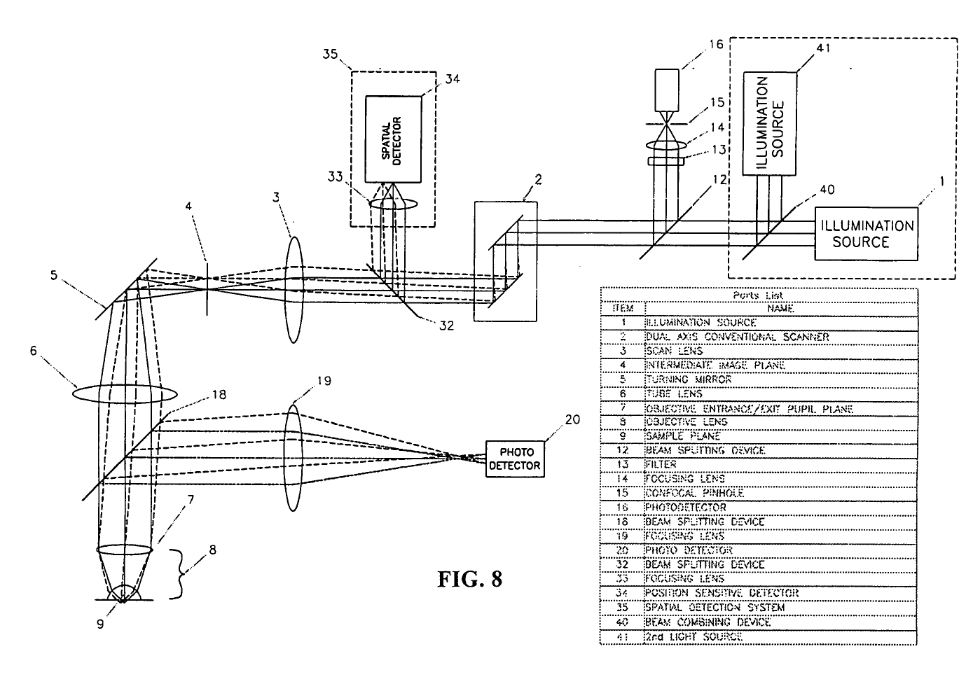

As depicted in FIG. 8, the feedback sub-assembly takes the form of a spatial detector system 35 comprising a spatial detector 34 and corresponding focusing lens 33. As shown in FIG. 8, the spatial detector system 35 may be used alone, without the addition of the series scan devices. In this version of the invention, the feedback mechanism is principally used as means of compensating for differences in excitation light input angles from multiple input sources. The device shown in FIG. 8 is identical to the convention apparatus shown in FIG. 3, with the addition of a descanned confocal detector (comprised of filter 13, focusing lens 14, confocal pinhole 15, and photodetector 16) and two illumination sources 1 and 41. A beam combiner 40 is provided to combine the excitation beams from illumination sources 1 and 41 into a single combined input beam. When two or more input sources are used, any angular difference in the combined sources will result in a difference in location of the associated focused spots at the sample plane. The feedback information provided by the spatial detection system 35 enables the registration of the combined excitation beam to be improved and monitored.

In FIG. 8, a second excitation source 41 has been combined into the original excitation path via a beam-combining device 40. The combined excitation travels through the rest of the system in the manner described earlier. A beam splitting device 32 is inserted in the path to intercept a portion of the excitation light. This intercepted light is sent to a spatially sensitive photo detection system 35. This dimensionally sensitive photo detection system is minimally comprised of a focusing lens 33 and a position sensitive detector 34 such as, for example, a position sensitive diode, a CCD camera, a three-dimensionally positionable pinhole plus photodetector, or an array of pinholes together with a photodetector. By the function of the focusing lens 33, variations in the angular direction of the excitation light are registered as variations in the spatial position of the focused spot at the position sensitive photo detector 34 and can be recorded electronically. The angular variation of the excitation light can be a result of a number of different phenomena, such as deflection of the scanning mechanism 2, or an error or variation in the directional combining action of the beam-combining device 40. In either case, the variation is registered at the position sensitive detector 34.

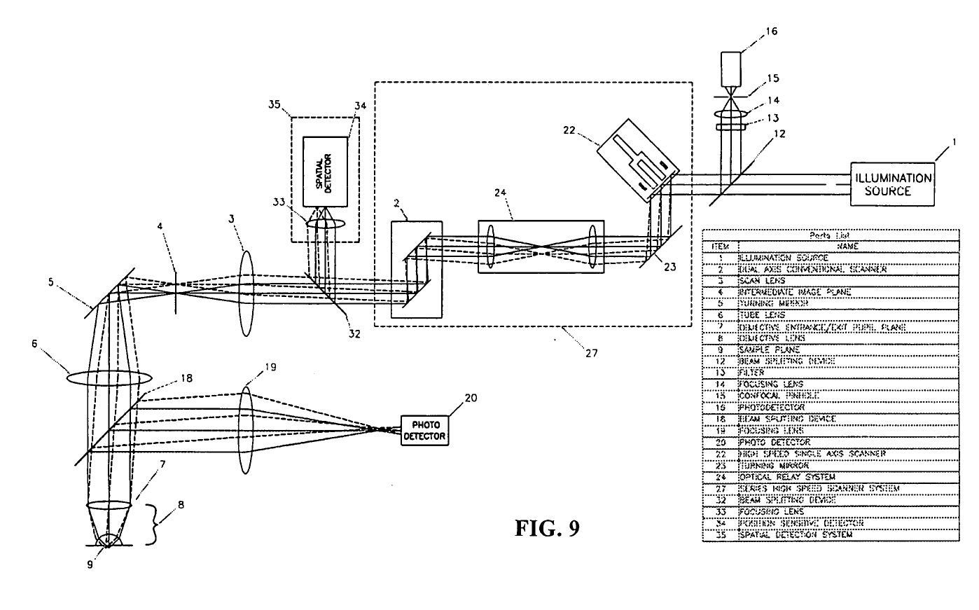

FIG. 9 shows an implementation of the feedback mechanism with the hybrid scanner design as depicted in FIG. 7. Thus, FIG. 9 shows a hybrid scanner mechanism comprising a single-axis high-speed scanner 22 placed in series with a conventional galvanometric scanner 22, as described previously. A single illumination source 1 is used. Here the spatial detection system 35 is positioned within the beam at a point such that it detects the sum of the deflections generated by scanners 2 and 22. By holding one scanner stationary as a reference, the relative deflection of the other scanner can be measured and a calibration developed. The calibration figures can then be used to accurately guide and position the scanners as desired for any particular application or protocol.

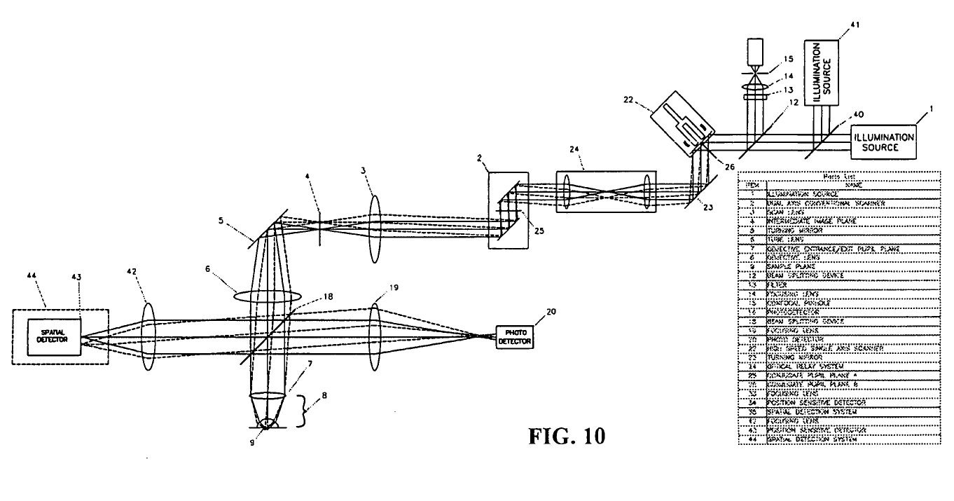

FIG. 10 depicts yet another version of the invention that is, in essence, a combination of the devices shown in FIGS. 8 and 9, with the spatial detection system (given reference number 44 in FIG. 10) being repositioned to sample a portion of the beam at a point between the tube lens 6 and the object lens 8. Thus, in FIG. 10, a beam splitting device 18 is positioned between the tube lens 6 and the objective lens 8. The beam splitter 18 is used deflects a small portion of the excitation light to the spatial detection system 44. The device depicted in FIG. 10 further includes two illumination sources 1 and 44, a beam combiner to combine the two input sources, complementary serial scanners 22 and 2 as described earlier, descanned confocal detector (comprising filter 13, lens 14, and pinhole 15, and photodetector), and non-descanned detector comprising lens 19 and photodetector 20.

Two distinct advantages are achieved with the version of the invention depicted in FIG. 10. First, an additional beam splitting device placed in the excitation path is not required for this implementation, in contrast to the device depicted in FIG. 9 (which requires using beam splitter 32 to direct a portion of the excitation beam into the spatial detection system. Second, with the spatial detection system located in the position shown in FIG. 10, the spatial detection system will also detect any lateral chromatic effects on the beam positions contributed by the scan lens 3 and the tube lens 6.

What is claimed is:

1. A scanning microscope comprising at least two scanners disposed in series within an excitation beam, wherein one of the scanners comprises a two-axis galvanometer-controlled scanner, and the other of the scanners comprises a single-axis resonant scanner.

2. The scanning microscope of claim 1, further comprising at least two illumination sources and a beam combiner configured to combine illumination generated by the at least two illumination sources into a combined excitation beam.

3. The microscope of claim 2, further comprising a descanned confocal photodetector.

4. The microscope of claim 2, further comprising a non-descanned photodetector.

5. The microscope of claim 2, further comprising a descanned confocal photodetector and a non-descanned photodetector.

6. The microscope of claim 1, further comprising a descanned confocal photodetector.

7. The microscope of claim 1, further comprising a non-descanned photodetector.

8. The microscope of claim 1, further comprising a descanned confocal photodetector and a non-descanned photodetector.

9. The microscope of any one of claims 1 though 8, further comprising a spatial detection system disposed within the excitation beam at a point downstream of the at least two scanners, wherein the spatial detection system is configured to detect a sum of deflections generated by the at least two scanners, or angular differences in the combined excitation beam when two or more illumination sources are used.

10. The microscope of claim 9, further comprising a scan lens, a tube lens, and an objective lens, and wherein the spatial detection system is disposed within the excitation beam at a point after the excitation beam has exited the scanners but prior to the excitation beam entering the scan lens.

11. The microscope of claim 9, further comprising a scan lens, a tube lens, and an objective lens, and wherein the spatial detection system is disposed within the excitation beam at a point after the excitation beam has exited the tube lens but prior to the excitation beam entering the objective lens.

12. A scanning microscope comprising at least three scanners disposed in series within an excitation beam, wherein one of the scanners is a two-axis galvanometer-controlled scanner, and the other two of the scanners are single-axis resonant scanners.

13. The microscope of claim 12, further comprising a descanned confocal photodetector.

14. The microscope of claim 12, further comprising a non-descanned photodetector.

15. The microscope of claim 12, further comprising a descanned confocal photodetector and a non-descanned photodetector.

16. The microscope of any one of claims 12 to 15, wherein the two single-axis resonance scanner are disposed orthogonally to one another.
